(19) United States
(12) Patent Application Publication
(10) Pub. No.: US 2006/0040114 A1
(43) Pub. Date: Feb. 23, 2006

(54) Silicone rubber composition containing mineral fibers

(75) Inventors: Peter Gerhardinger, Burghausen (DE); Peter Jerschow, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/193,263

(22) Filed: Jul. 29, 2005

(30) Foreign Application Priority Data
Aug. 19, 2004 (DE) 10 2004 040 265.5

(51) Int. Cl. B32B 25/02; B32B 25/20; C08L 83/04; B32B 9/04

(52) U.S. Cl. 428/447; 524/588; 524/860

(57) ABSTRACT

The invention relates to silicone rubber compositions which contain inorganic filler which is selected from metal oxides and silicon oxides and silicon-metal mixed oxides, and milled mineral fibers.

### BACKGROUND OF THE INVENTION

1. Field of the Invention

The invention relates to silicone rubber compositions which contain milled mineral fibers, and moldings and coatings comprising the silicone rubber compositions.

2. Background Art

U.S. Pat. No. 6,387,518 describes filled silicone rubber for safety cables. The silicone rubber contains metal oxides. The insulation comprising the silicone rubber burns in the event of a fire and, together with the metal oxide, forms a ceramic which is electrically insulating. Consequently, a short-circuit between the conductors of the cable is prevented and functioning of the cable is maintained.

DE-A-19717645 describes ceramizable flame-retardant compositions which contain silicone rubber and ceramizing sintering fillers.

Certain standards require high flexibility of the cable in the event of a fire, as a result of which the ceramic crumbles and maintenance of functioning is not ensured.

U.S. Pat. No. 6,387,518 also mentions glass fibers as fillers. However, such fillers are very difficult to incorporate into silicone rubber and have an adverse effect on the dielectric strength of the silicone rubber.

### SUMMARY OF THE INVENTION

The invention relates to silicone rubber compositions which contain inorganic filler which is selected from metal oxides and silicon oxides and silicon-metal mixed oxides, and milled mineral fibers.

### DETAILED DESCRIPTION OF THE PREFERRED EMBODIMENT(S)

The silicone rubber compositions ceramize even when they are ashed in the uncrosslinked state. The crosslinked silicone rubber compositions not only have improved mechanical properties of the silicone elastomer, for example high tensile strength, but also exhibit good electrical properties. In the event of a fire, a mechanically stable ceramic which still has good electrical insulation properties forms together with the inorganic filler and the milled mineral fibers, as a result of combustion of the silicone elastomer. In particular, the ceramic is less brittle since the glass fibers are incorporated by ceramization and strengthen the ceramic, as is the case with steel reinforcements in reinforced concrete.

Owing to the milling, the mineral fibers can be incorporated without problems into the silicone rubber compositions.

In addition, these mineral fibers in the silicone compositions result in increased resistance to nonpolar media. Nonpolar media are understood as meaning all nonpolar liquids in which silicone rubbers swell during the action thereof. Nonpolar media are, for example, mineral oils, such as paraffins, and processed mineral oils, such as fuels, e.g. diesel oil, kerosene and gasoline.

By coating the fibers with adhesion promoters, in particular with silanes, the increased resistance to nonpolar media is further enhanced. The same effect occurs if adhesion promoters are present in the silicone rubber.

The silicone rubber compositions are crosslinkable to give silicone rubber. For example, the silicone rubber compositions may be peroxidically crosslinking, condensation-crosslinking or addition-crosslinking. Customary condensation-crosslinking organopolysiloxanes, as for example those described in EP-A-359251, hereby incorporated by reference, or known addition-crosslinking or peroxidically crosslinking materials, can be used as silicone rubber.

Preferably, the silicone rubber compositions are peroxidically crosslinking and preferably contain the following components:

Organopolysiloxanes comprising units of the general formula I
RᵣSiO_{(4-r)/2}
in which
R are identical or different optionally substituted hydrocarbon radicals and
r is 0, 1, 2 or 3, and has an average numerical value from 1.9 to 2.1.

Examples of hydrocarbon radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,4,4-trimethylpentyl radical, nonyl radicals such as the n-nonyl radical, decyl radicals such as the n-decyl radical, dodecyl radicals such as the n-dodecyl radical, octadecyl radicals such as the n-octadecyl radical; cycloalkyl radicals such as cyclopentyl, cyclohexyl and cycloheptyl radicals and methylcyclohexyl radicals; aryl radicals such as the phenyl, biphenyl, naphthyl, anthryl, and phenanthryl radicals; alkaryl radicals such as the o-, — and p-tolyl radicals, xylyl radicals and ethylphenyl radicals; and aralkyl radicals such as the benzyl radical and the -α and the β-phenylethyl radicals.

Examples of substituted hydrocarbon radicals R are halogenated alkyl radicals such as the 3-chloropropyl, the 3,3,3-trifluoropropyl and the perfluorohexylethyl radical, and halogenated aryl radicals such as the p-chlorophenyl radical and the p-chlorobenzyl radical.

Further examples of radicals R are the vinyl, allyl, methallyl, 1-propenyl, 1-butenyl, 1-pentenyl radical, 5-hexenyl, butadienyl, hexadienyl, cyclopentenyl, cyclopentadienyl, cyclohexenyl, ethynyl, propargyl and 1-propynyl radicals.

Radical R is preferably a hydrogen atom or a hydrocarbon radical having 1 to 8 carbon atoms, in particular, a methyl, phenyl or vinyl radical.

Preferably, alkyl radicals, in particular methyl radicals, are bonded to at least 70 mol %, in particular at least 90 mol %, of the Si atoms contained in the organopolysiloxane. If, in addition to Si-bonded methyl and/or 3,3,3-trifluoropropyl radicals, the organopolysiloxanes also contain Si-bonded vinyl and/or phenyl radicals, the latter are preferably present in amounts of 0.001-30 mol %.

Preferably, the organopolysiloxanes comprise predominantly, and in particular at least 95 mol %, of diorganosiloxane units. The terminal groups of the organopolysiloxanes may be trialkylsiloxy groups, in particular the trimethylsiloxy radical or the dimethylvinylsiloxy radical; however, one or more of these alkyl groups may also be replaced by hydroxyl groups or alkoxy groups, such as methoxy or ethoxy radicals.

The organopolysiloxanes may be liquids or highly viscous substances. The organopolysiloxanes preferably have a viscosity of from 10³ to 10⁸ mm²/s at 25° C.

Peroxides, such as dibenzoyl peroxide, bis(2,4-dichlorobenzoyl) peroxide, dicumyl peroxide and 2,5-bis(tert-butylperoxy)-2,5-dimethylhexane and mixtures thereof are preferably used as crosslinking agents in the silicone rubber materials, bis(2,4-dichlorobenzoyl) peroxide and 2,5-bis(tert-butylperoxy)-2,5-dimethylhexane being preferred.

Furthermore, a mixture of bis(4-methylbezoyl) peroxide (“PMBP”) and 2,5-dimethylhexane-2,5-di-tert-butyl peroxide (“DHBP”) in a ratio of from 1:0.4 to 0.5:1, preferably in the ratio 1:0.4, is preferably used as the crosslinking agent.

Examples of plasticizers which can be used as additives are polydimethylsiloxanes terminated with trimethylsilyl groups or hydroxyl groups and having a viscosity of not more than 1000 mm²/s at 25° C., or diphenylsilanediol.

Examples of heat stabilizers which can be used as additives are salts of transition metals with fatty acids, such as iron octanoate, transition metal silanolates such as iron silanolate, and cerium(IV) compounds, oxides and hydroxides of these metals, and carbon blacks.

The inorganic filler may be reinforcing or non-reinforcing.

Examples of reinforcing fillers are pyrogenic or precipitated silicas having BET surface areas of at least 50 m²/g. Such silica fillers may have a hydrophilic character or may be rendered hydrophobic by known methods. In this context, reference may be made, for example, to U.S. Pat. No. 5,057,151. In general, the hydrophobic treatment is then effected with from 1 to 20% by weight of hexamethyldisilazane and/or divinyltetramethyldisilazane and from 0.5 to 5% by weight of water, based in each case on the total weight of the silicone rubber compositions, these reagents advantageously being added to the initially introduced organopolysiloxane in a suitable mixing apparatus, such as, for example, a kneader or internal mixer, before the hydrophilic silica is gradually incorporated into the material.

Examples of nonreinforcing fillers are quartz powder, diatomaceous earth, calcium silicate, zirconium silicate, zeolites, metal oxide powders, such as aluminum oxide, titanium oxide, iron oxide or zinc oxide, barium silicate, barium sulfate, calcium carbonate, gypsum, enamel, glass frits, solder glasses and clays. The BET surface area of these fillers is preferably less than 50 m²/g.

Ceramizing fillers which are selected from magnesium oxide, aluminum oxide, tin oxide, calcium oxide, titanium oxide, barium oxide and silicon dioxide and compounds of the metals magnesium, aluminum, tin, calcium, titanium and barium and silicon, where oxides form on heating, in particular the hydroxides thereof, boric acid and zinc borate, are preferred.

The silicone rubber compositions preferably contain from 10 to 80% by weight, more preferably from 20 to 60% by weight, of inorganic filler.

The ceramizing silicone rubber compositions preferably contain platinum compounds. The silicone rubber preferably contains platinum complexes which have at least one unsaturated group, such as platinum-olefin complexes, platinum-aldehyde complexes, platinum-ketone complexes, platinum-vinylsiloxane complexes, platinum-1,3-divinyl-1,1,3,3-tetramethyldisiloxane complexes with or without a content of detectable organic halogen, platinum-norbornadiene-methylacetonate complexes, bis(gamma-picoline)platinum dichloride, tetramethylenedipyridineplatinum dichloride, dicyclopentadienylplatinum dichloride, dimethylsulfoxydiethyleneplatinum(II) dichloride, reaction products of platinum tetrachloride with olefin and primary amine or secondary amine or primary and secondary amine, a reaction product of platinum tetrachloride, dissolved in 1-octene, with sec-butylamine, the platinum-1,3-divinyl-1,1,3,3-tetramethyldisiloxane complex being particularly preferred. This platinum complex is added in amounts of from 5 to 200 ppm, preferably from 10 to 100 ppm, the amount being based on pure platinum. Mixtures of the platinum complexes may also be used.

The milled mineral fibers are preferably ceramic fibers or glass fibers. Examples of ceramic fibers are aluminum oxide, zirconium oxide, slag fibers, rock wool, glass fibers; in particular glass fibers or rock wool. For ceramizing compositions, the glass fibers preferably have a low content of conductive ions. As a result of milling, the mineral fibers are preferably on average from 30 to 500 μm long. The milled mineral fibers have, in particular, an average length of from 100 to 300 μm. The average diameter of the mineral fibers is preferably from 0.1 to 20 μm. For the production of cables, alkali-free or low-alkali mineral fibers are preferably used.

The respective components of the silicone rubber compositions may be in each case an individual type of such a component as well as a mixture of at least two different types of such a component.

The invention furthermore relates to moldings and coatings comprising the silicone rubber compositions, and the crosslinked moldings and coatings. Preferred coatings are fabric coatings. Preferred moldings are, for example, the insulating covering around electrical conductors, protective covering and outer sheath, and profiles which serve for fire protection, such as construction profiles.

All symbols of the above formulae have their meanings in each case independently of one another. Unless stated otherwise, all quantity and percentage data in the following examples are based on weight, and all pressures are 0.10 MPa (abs.) and all temperatures are 20° C.

### EXAMPLE 1

Regarding the increase in the resistance to media, measured from the volume increase after storage of a 6 mm thick tablet having a diameter of 10 mm for 7 days in diesel oil at 23° C.:

| | A | B | C |
|---|---|---|---|
| | parts by wt. | parts by wt. | parts by wt. |
| Silicone rubber | 100 | 100 | 100 |
| Glass fibers, 150 μm | 0 | 10 | 25 |
| Volume increase after storage | 72% | 42% | 48% |

### EXAMPLE 2

Regarding the increase in the resistance to media, measured from the volume increase after storage of a 6 mm thick tablet having a diameter of 10 mm for 7 days in diesel oil at 23° C.:

| | A | B | C |
|---|---|---|---|
| | parts by wt. | parts by wt. | parts by wt. |
| Silicone rubber | 100 | 100 | 100 |
| Glass fibers 230 μm | 0 | 10 | 25 |
| Volume increase after storage | 72% | 42% | 48% |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A ceramifyable silicone rubber composition, comprising a crosslinkable organopolysiloxane elastomer, at least one inorganic filler selected from the group consisting of metal oxides, silicon oxides, silicon-metal mixed oxides and mixtures thereof, and further comprising at least one milled mineral fiber.

2. The silicone rubber composition of claim 1, which is peroxidically crosslinkable, condensation-crosslinkable or addition-crosslinkable.

3. The silicone rubber composition of claim 1, in which the inorganic filler is selected from the group consisting silicon dioxide, magnesium oxide, aluminum oxide, tin oxide, calcium oxide, titanium oxide, barium oxide, and mixtures thereof.

4. The silicone rubber composition of claim 1, in which at least one milled mineral fiber is selected from the group consisting of ceramic fibers and glass fibers.

5. The silicone rubber composition of claim 1, in which the mineral fibers are on average from 30 to 500 μm long.

6. A molding or coating comprising the silicone rubber composition of claim 1.

7. An electrical cable, comprising at least one electrical conductor, and surrounding said conductor, a layer of crosslinked silicone rubber composition of claim 1.

8. The electrical cable of claim 7, wherein said layer is immediately adjacent said conductor.
